(19) United States
(12) Patent Application Publication
(10) Pub. No.: US 2019/0080283 A1
(43) Pub. Date: Mar. 14, 2019

(54) System and Method for Pallet Optimization

(71) Applicant: Walmart Apollo, LLC, Bentonville, AR (US)

(72) Inventor: Andrew B. Millhouse, Gilbert, AZ (US)

(21) Appl. No.: 16/130,057

(22) Filed: Sep. 13, 2018

Related U.S. Application Data
(60) Provisional application No. 62/558,813, filed on Sep. 14, 2017.

(51) Int. Cl. G06Q 10/08; B07C 5/10; B65G 61/00; G01B 11/25

(52) U.S. Cl. CPC G06Q 10/087; G01B 11/254; B65G 61/00; B07C 5/10

(57) ABSTRACT

Described in detail herein is a system and method for the creation of a best pallet build. The system utilizes trip information as well as product dimensional data to build an optimized virtual three dimensional model of the fully built pallet. Utilizing the virtual three dimensional model, the system creates a slideshow of footprint images, corresponding to each of the products placed on the pallet build. The system then projects the footprint images onto the pallet indicating correct placement of the product on the pallet build. The system utilizes a system of scales attached to the forks of a forklift to measure placement, and detect correct or incorrect placement of the product.

### CROSS-REFERENCE TO RELATED PATENT APPLICATION

This application claims priority to U.S. Provisional Application 62/558,813 filed on Sep. 14, 2017, the content of which is hereby incorporated by reference in its entirety.

### BACKGROUND

Pallets are frequently used during the transport and/or storage of goods. The pallets may be loaded with multiple layers of items. The pallets may be loaded so that they only contain one type of item or may be mixed pallets that include different types of items. Certain items have specified handling criteria that indicate how the items may be loaded onto a pallet.

### SUMMARY

In one embodiment, an electronic device is coupled with a forklift. The electronic device calculates a three dimensional (3D) model based on the dimensions of items to be palletized. The electronic device creates a slideshow based on the 3D model where each slide illustrates the footprint and location of an item to be placed on the pallet. A projector mounted on a mast attached to the pallet, projects the slideshow onto the pallet, illustrating a correct placement of the item. Upon placement of the item, scales register the weight of the placed item on the pallet to determine correct placement. The electronic device determines based on the weight measured by scales at various points on the forklift, if the item was placed correctly. If the item was placed incorrectly, the electronic device utilizes the projector to notify the user. If the item was placed correctly the electronic device proceeds updates the slideshow and projects the next image in the slideshow through the projector.

In one embodiment, an electronic device is coupled with a trailer. The electronic device calculates a three dimensional (3D) model based on the dimensions of items to be placed within the trailer. The electronic device creates a slideshow based on the 3D model where each slide illustrates the footprint and location of an item to be placed in the trailer. A projector mounted outside the trailer, projects the slideshow onto the floor of the trailer, illustrating a correct placement of the item within the trailer. Upon placement of the item, scales register the weight of the placed item on the pallet to determine correct placement. The electronic device determines based on the weight measured by scales at various points under the trailer, if the item was placed correctly. If the item was placed incorrectly, the electronic device utilizes the projector to notify the user. If the item was placed correctly the electronic device proceeds updates the slideshow and projects the next image in the slideshow through the projector.

### BRIEF DESCRIPTION OF DRAWINGS

Illustrative embodiments are shown by way of example in the accompanying drawings and should not be considered as a limitation of the present disclosure:

FIG. 1 is a diagram illustrating a system for creating an optimized pallet build according to an exemplary embodiment.

FIG. 2 is a diagram illustrating a top view of a system for creating an optimized pallet build according to an exemplary embodiment.

FIG. 3 is a block diagram illustrating the data flow through system components for creating an optimized pallet build according to an exemplary embodiment.

FIG. 4 is a flow chart illustrating a process for creating an optimized pallet build according to an exemplary embodiment.

FIG. 5 is flow chart illustrating a process for creating an optimized pallet build according to another exemplary embodiment.

FIG. 6 is a block diagram illustrating an exemplary electronic device suitable for use in an exemplary embodiment.

### DETAILED DESCRIPTION

Described in detail herein is a system for optimizing pallet builds.

As disclosed herein, a forklift may include any loading device utilized to move pallets from one place to another. A forklift may be motorized, or manual, and may include vehicular implementations as well as non-vehicular “pallet jacks.”

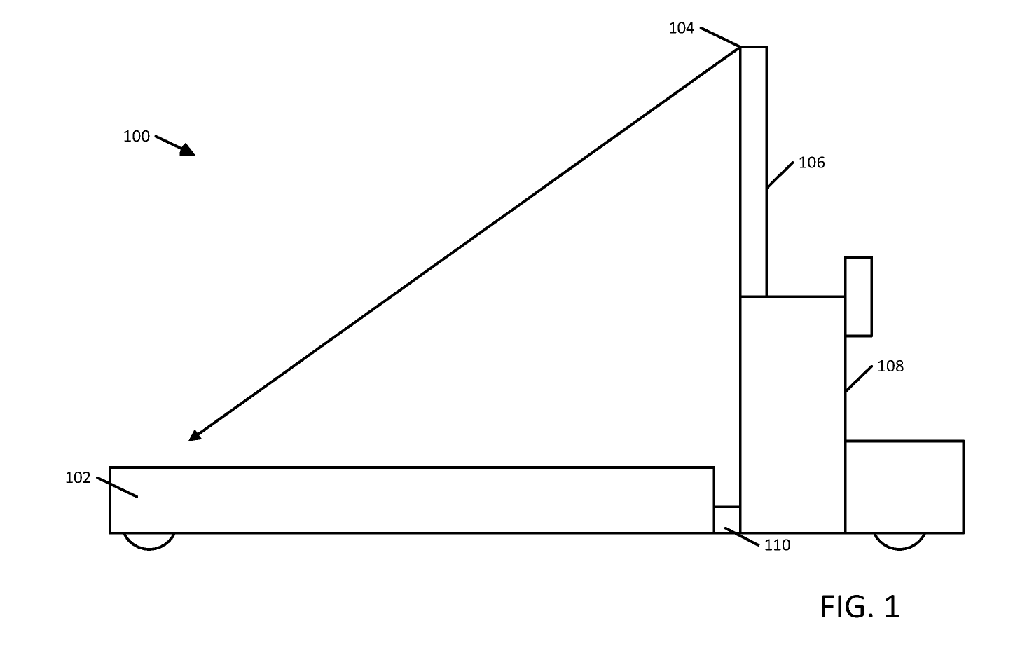

FIG. 1 is a diagram illustrating a pallet building system 100 for creating an optimized pallet build according to an exemplary embodiment. As used herein the term “pallet build” refers to the process of loading items onto a pallet in a defined order for storage or transport. The pallet building system 100 includes a pallet 102. The pallet 102 provides support for items during storage and shipment. The pallet 102 may be constructed of various different materials including but not limited to polymers, woods, and metals. The pallet 102 may be constructed to accept forks 110 through the interior of the pallet 102, so that the pallet 102 may be raised from the ground and transported via a forklift or other transportation mechanism.

The forks 110 may be integral to the forklift itself. The forks 110 may be of varying length and operable to interface with various types of pallets 102. In some configurations, the forks 110 are deployed in pairs, however in other embodiments, the forks 110 may be otherwise deployed based on the configuration of the pallet 102 to be utilized.

The optimized pallet building system 100 may include a housing 108. The housing 108 may internally include hydraulics for operating the forklift. Additionally, the housing 108 may include an electronic device that includes a processor for executing instructions for controlling the pallet building system 100 for creating an optimized pallet build. Alternatively, the housing 108 may include a transceiver operable to communicate with a remote electronic device. The transceiver may operate as a proxy, relaying instructions from the remote electronic device to a projector 104. Additionally, the housing 108 may include other display devices, touchscreen devices, and/or audio devices coupled to the electronic device or transceiver.

The pallet building system 100 may include a mast 106. The mast 106 provides the physical support for a projector 104. The mast 106 may be of fixed or varying height and enable projector 104 to project an image onto the pallet 102 or onto items on the pallet that is discernable by a user. The projector 104 may be configured to communicated is a wired or wireless fashion with an electronic device or transceiver. The projector 104 may provide for keystone correction to allow for dimensionally correct images to be projected onto the pallet 102. Keystone correction allows for the correction of a projected image at the source, so that the output image displays with no distortion due to the positioning of the projector.

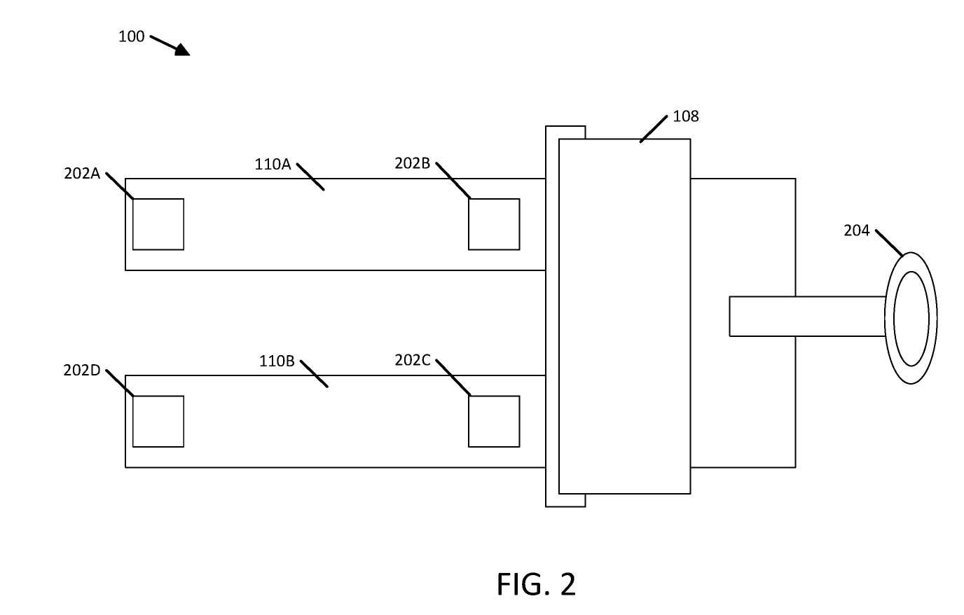

FIG. 2 is a diagram illustrating a top view of a pallet building system 100 for creating an optimized pallet build according to an exemplary embodiment. The pallet building system 100 includes forks 110A, 110B. Coupled to the forks 110A, 110B, may be multiple scales 202A, 202B, 202C, 202D. The scales 202A, 202B, 202C, 202D may include the ability to measure larger weights consistent with that of pallets and their contents. Additionally, the scales 202A, 202B, 202C, 202D may transmit weight measurements to an electronic device either directly or through a transceiver. The scales 202A, 202B, 202C, 202D may be placed in a symmetrical pattern across the forks 110A, 110B as shown in FIG. 2 or may be otherwise arranged such that they may determine a weight reading when an item is placed on a pallet resting on one of the forks. The scales 202A, 202B, 202C, 202D may include a tare operation internally, or may be virtually tared by the electronic device. A handle 204 may be attached to the housing 108 for operation of the hydraulics as well as for manual transport.

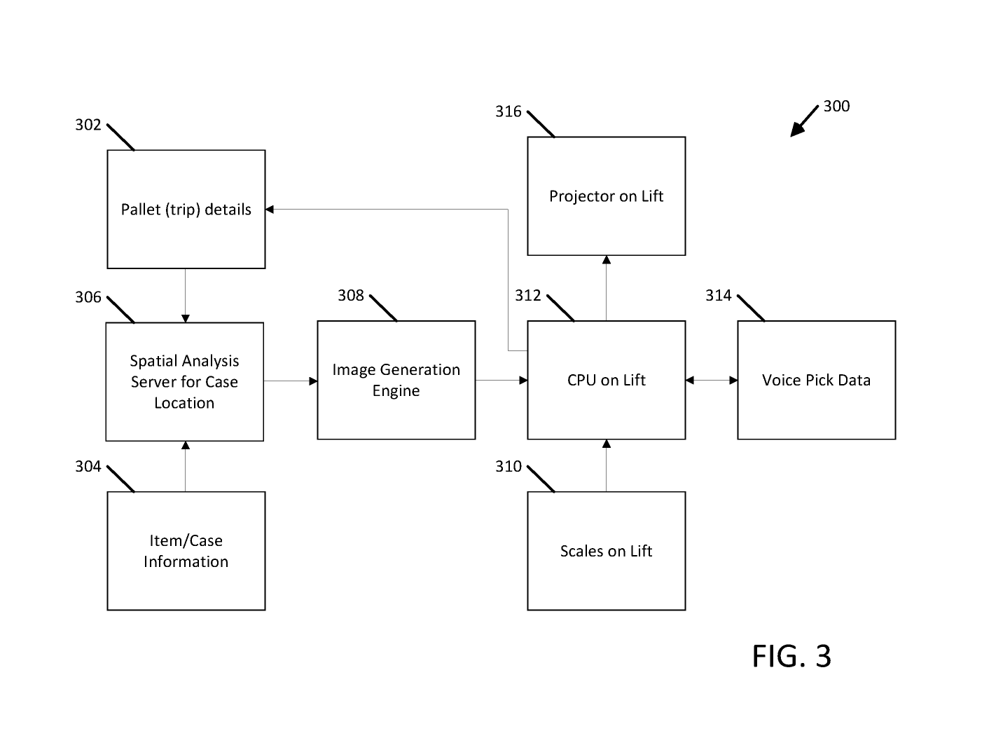

FIG. 3 is a block diagram illustrating the data flow 300 through system components for creating an optimized pallet build according to an exemplary embodiment. The data flow 300 describes relationships between components of the system and the points in the system where information is processed.

The data flow 300 may begin with an optimization module executed by a processor on a computing device retrieving pallet data 302. The pallet data 302 includes information identifying the items to be placed on the pallet. Additionally, the pallet data 302 may include information regarding the location of the items within a storage facility from which they are being “picked”/retrieved. In one embodiment, pallet data 302 may be lists of items, with corresponding location information, that are iteratively processed as items in the list are located and processed.

The optimization module may also retrieve item information 304. Item information 304 may correspond to a single item or a case of items in a picking operation designed to retrieve the items and place them on a pallet for transport/storage. The item information 304 may include the physical dimensions of the packaging, and weight of an item or case of items.

The optimization module may also include a spatial analysis server (SAS) 306 and an image generation engine 308. The pallet data 302 and the item information 304 may be input into the SAS 306. The SAS 306 examines the item for the current trip and evaluates the available space on the pallet against the dimensions contained in the item information 304. A trip may include identifying of an item for loading on a pallet, the travelling to the location hosting that item, the picking of the item, and placement of the item on a pallet. The SAS 306 makes a best fit determination for the current item in the pallet data 302 using the dimensions of the items. Alternatively, the SAS 306 may take pallet data 302 including the list of items in all trips with the corresponding item information 304, and any pre-defined constraints for the items, and virtually build a 3D model of an entire pallet. The 3D model may be used to reorder any items in the pallet data 302 so that space on the pallet and travel around the storage facility is efficient. The 3D model may include multiple layers or cross sections of items having assigned locations on the pallet within the layers. The pre-defined constraints may include item-specific constraints based on the type of item. For example, refrigerated items may include a constraint that prevents the items from being loaded on a pallet with non-refrigerated items. As another non-limiting example, chicken items may include the constraint that they not be located above any other items on the pallet so as to prevent the spread of bacteria.

The resulting best fit determination from the SAS 306 may then be input to the image generation engine 308. The image generation engine 308 utilizes the item information 304 and the best fit determination to generate an image respective to the placement of the item on the pallet. For example, the image generation engine 308 utilizes the dimensions of the footprint of an item, and creates an image of the footprint correctly spaced on the pallet based on the best fit determination. In another embodiment where the 3D model of the virtual pallet has been constructed, the image generation engine 308 creates a list of images corresponding to the footprint of each item in the virtual pallet, based on the best fit determination. The individual images in each layer may then be transmitted to the projector for projection onto the pallet or onto the top of an item already on the pallet to indicate the correct positioning of the next item to be placed from a layer in the 3D model.

The pallet optimization system may include a central processing unit (CPU) 312 located on a forklift. The resulting image from the image generation engine 308 may be transmitted to the CPU 312 on the forklift. It will be appreciated that in an alternate embodiment the image generation engine 308 may instead be part of a computing device on the forklift. The pallet optimization module may receive feedback from the scales 310 on the forklift, and may provide instructions to the projector 316 to project a specified image based upon whether or not the weight readings from the scales indicate an item was accurately placed on the pallet. Additionally, the optimization module may send and receive voice pick data 314 to an audio device on the forklift to audibly instruct a picker responsible for retrieving items and/or loading the pallet. The audio device may be attached to the pallet or forklift or a locally disposed and configured to communicate with the CPU 312 in a wired or wireless manner.

The optimization module outputs images from the image generation engine 308 to the projector 316 on the forklift. The projector 316 projects the image corresponding to footprint of the item in a best fit configuration onto the pallet. An individual (e.g.: a picker) places the item in in the footprint. The scales 310 on the forklift receive input from the placement, and provide that input to the CPU 312 and optimization module. In one embodiment, the placement of the item may be followed with voice commands from the picker, requesting to move to the next item. The optimization module receives the input from the Voice Pick Data 314 and provides instructions to move to the next item in the pallet data 302.

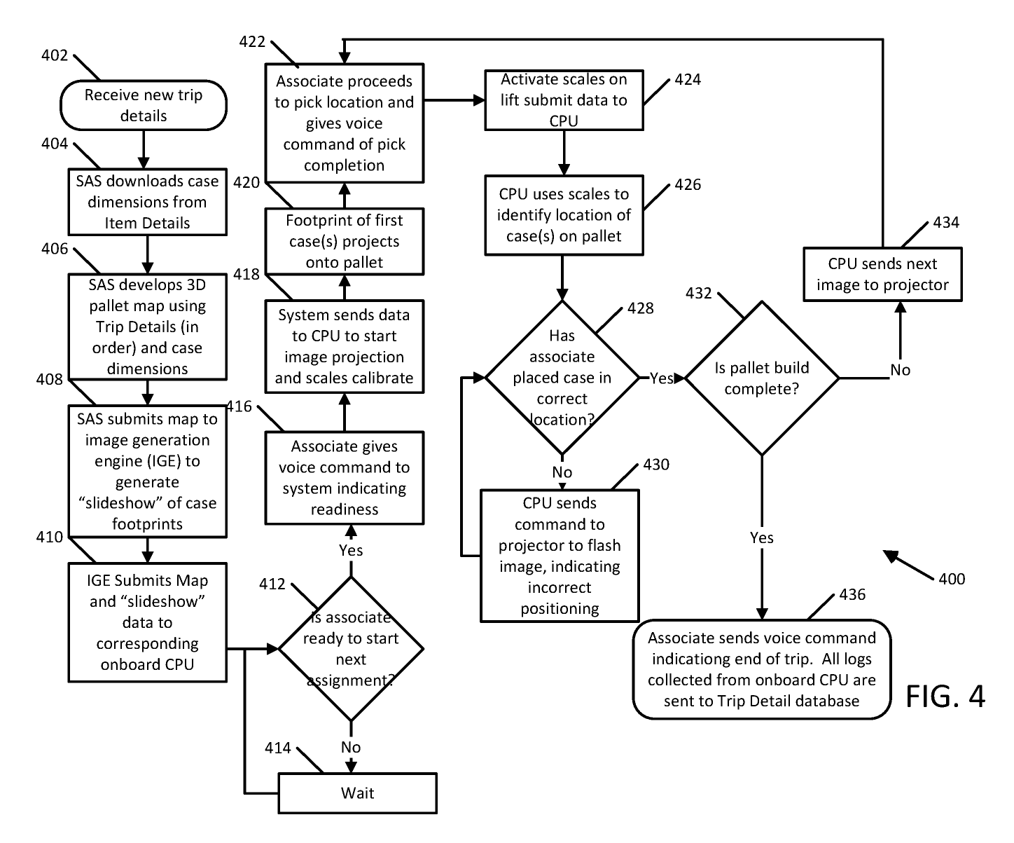

FIG. 4 is a flow chart illustrating a process for creating an optimized pallet build according to an exemplary embodiment.

The process begins when the system receives new trip data 402. The trip data may include items or cases to be included in the pallet build. The trip data 402 may be received electronically in the form of a manifest for the pallet build.

The SAS downloads case dimensions from item data 404. Based on the trip data, the SAS may retrieve information about the items or cases to be placed on the pallet. Dimensions may include package volumetric dimensions as well as weights. Alternatively, the SAS may also retrieve location information, in relation to the storage facility, as to where the items or cases are housed.

The SAS develops a virtual 3D model (also referred to herein as “3D pallet map”) using trip data (in order) and case dimensions 406. The SAS utilizes the trip data to determine optimal placement of an item or case on a pallet based on the volumetric dimensions and weight. The SAS may organize the item or case placement in the 3D pallet map based on the order submitted in the trip data, or alternatively, on the most efficient route through the storage facility.

The SAS submits the 3D pallet map to image generation engine (IGE) to generate “slideshow” of case footprints 408. The IGE utilizes 3D pallet map to “slice” the 3D pallet based on each item or case placed on the 3D pallet map. The images may contain an identifiable footprint of the item or case to be placed on the pallet build for that trip. The identifiable footprint may be located with the image at the location of placement relative to the surface of the pallet. Alternatively, the image may also include previously placed items or cases identifiable in a different manner (e.g., a different color or pattern). An image may be generated for each of the items or cases to be placed in the pallet build as determined by the 3D pallet map. The IGE then submits map and “slideshow” data to corresponding onboard CPU 410.

The system then determines if a picker is ready to start their next assignment 412. The determination may include prompts provided on an attached display or touchscreen. If the picker is not ready, the system will wait 414, for a predetermined period of time. Upon the expiration of the predetermined period of time, the system will then determine if the picker is ready to start their next assignment 412.

If the system determines that the picker is ready to start the next assignment, the picker gives voice command to system indicating readiness 416. Alternatively, the picker may give other forms of input to the system indicating readiness such as selecting an option on a touchscreen, providing input through a keyboard, or pressing a button.

Instructions may be sent to the forklift to prepare for image projection and to calibrate the scales calibrate 418. The instructions to the image projector may instruct the projector to prepare for the display of the “slideshow” of images. The instructions to calibrate may include instructions to tare the scales. Alternatively, the calibration may be the request of a reading of a baseline load on the scales, and the CPU on the forklift tares the scales utilizing the baseline.

The footprint of first case(s) projects onto pallet 420. The projector projects the first image of the “slideshow” containing the footprint of the first item or case onto the pallet. The picker proceeds to a pick location and gives a command of pick completion 422. The picker may attempt to place the item or cases within the footprint, as projected by the projector. The picker provides notification of pick completion either through voice command or through manual input methods.

The system then activates scales on the forklift to submit data to the optimization module. Each of the scales is activated and a measurement is taken upon the notification of completion of the pick. The scales transmit their respective measurements to the optimization module. The optimization module utilizes the measurements from the scales to locate the position of the item or case on the pallet. The optimization module may use triangulation based on the weight measurements. The optimization module may calculate a center of gravity of the package based on the weight measurements, and match the calculated center of gravity to that of a predicted center of gravity extrapolated from the 3D pallet map.

The system then determines whether the picker has placed the case in a correct location 428 based on the weight measurements. If the placement is incorrect, the optimization module sends a command to the projector to flash an image, indicating incorrect positioning 430. The flashed image may augment the original projected color of the footprint to another color to indicate incorrect placement. For example, if the footprint in the original image was depicted as yellow, incorrect placement may yield a change of color of the footprint to red. Alternatively, the flashed image may be of a different shape altogether. For example, if the item or case was placed incorrectly, the image may be changed or augmented to include a hexagonal stop sign.

If the system determines that the picker placed the case in the correct location, the system then determines if pallet build is complete 432. The system evaluates if there are any remaining trips in the trip data that have not yet been fulfilled. If the system determines there are remaining trips or items to place on the pallet, the optimization module sends the next image to projector 434, and the picker proceeds to the pick location and gives voice command of pick completion 422.

If the pallet build is complete, the picker sends a voice command indicating end of trip. All logs may be collected from an onboard CPU (on the pallet or forklift) and sent to a trip detail database 436.

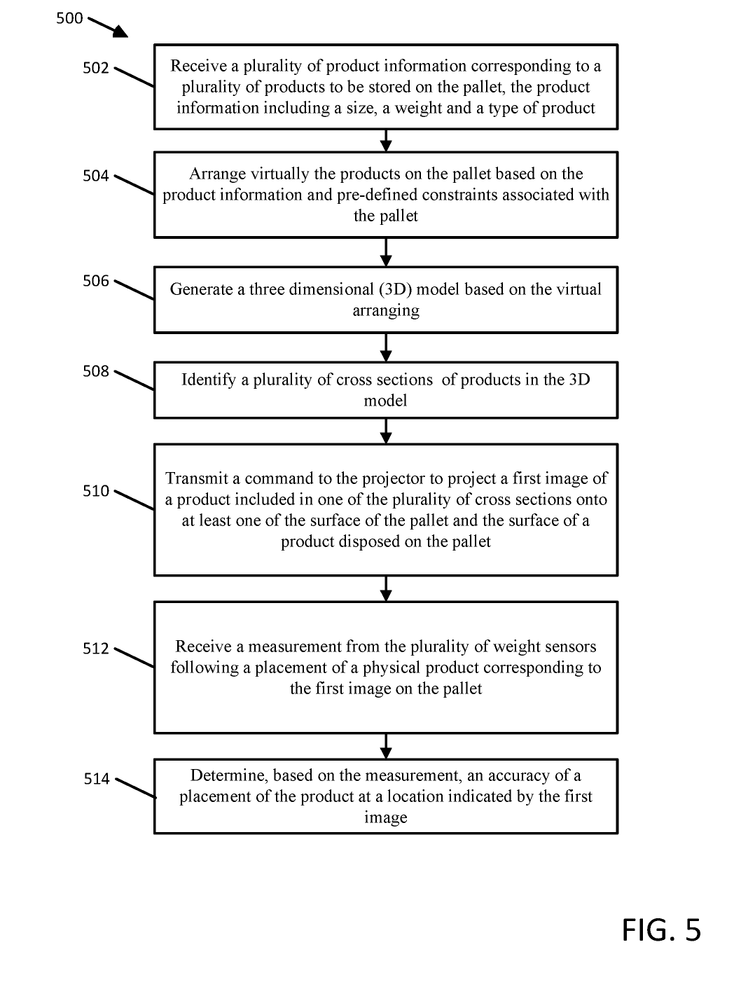

FIG. 5 is flow chart illustrating a process for creating an optimized pallet build according to another exemplary embodiment.

At step 502, the system receives item information corresponding to items to be stored on the pallet, the item information including a size, a weight, and a type of item. The item information may take the form of trip detail information. In addition to size, weight and types of items, the item information may include location information of the items in a storage facility.

At step 504, the system arranges virtually the items on the pallet based on the item information and pre-defined constraints associated with the pallet. The items may be placed virtually based on their dimensions, and weight. Alternatively, the items may be placed virtually based on their location in the storage facility to organize the most efficient trip through the storage facility.

At step 506, the system generates a three dimensional (3D) model based on the virtual arranging. The 3D model includes a representation of the physical dimensions of the items. The 3D model may be manipulated by the system during trips.

At step 508, the system identifies cross sections of items in the 3D model. The system may utilize the 3D model to identify cross sections pertaining to the footprint of an item at a certain point in the 3D model. The system identifies the plane that footprint resides in and creates a cross sectional image emphasizing the footprint of the item.

At step 510, the system transmits a command to the projector to project a first image of an item included in one of the cross sections onto the surface of the pallet and/or the surface of an item already disposed on the pallet. The first image is then projected. The projector may accommodate keystone correction features so that the projected image has the same geometry as the pallet.

At step 512, the system receives a measurement from the weight sensors following a placement of a physical item corresponding to the first image on the pallet. Weight sensors may include scales for the detection and measurement of weight on the pallet. The weight sensors may have the ability to self calibrate or tare, or alternatively, in conjunction with a CPU may perform a software calibration according to a baseline measurement.

At step 514, the system determines, based on the measurement, an accuracy of a placement of the item at a location indicated by the first image. Utilizing the measurements from the weight sensors, the optimization module may determine the location of the item placement by triangulation or by determining a center of gravity of the item matched to the a predicted center of gravity extrapolated from the 3D pallet map. For example, the optimization module may compare the received weight reading to an expected weight of the item and may compare the location of the responding weight sensor to the expected responding sensor based on the 3D model location of the item.

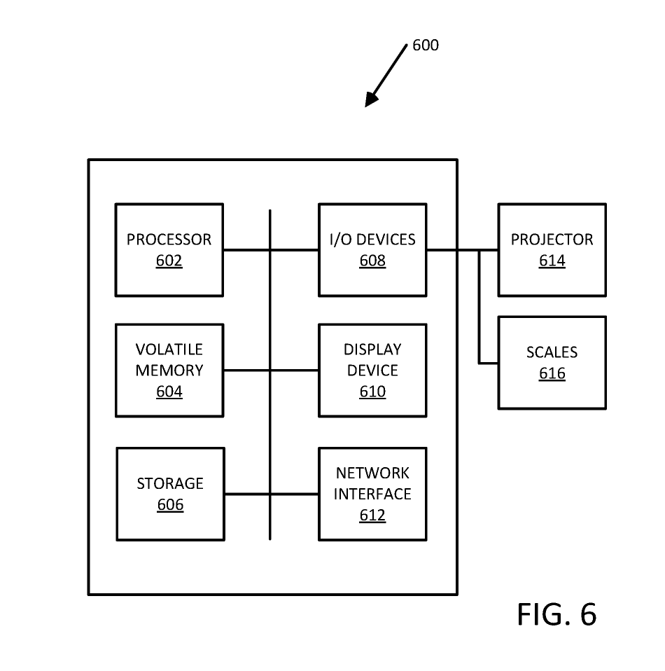

FIG. 6 is a block diagram illustrating an exemplary electronic device suitable for use in an exemplary embodiment. Electronic device 600 can execute the optimization module described herein. The electronic device 600 includes one or more non-transitory computer-readable media for storing one or more computer-executable instructions or software for implementing exemplary embodiments. The non-transitory computer-readable media may include, but are not limited to, one or more types of hardware memory, non-transitory tangible media (for example, one or more magnetic storage disks, one or more optical disks, one or more flash drives, one or more solid state disks), and the like. For example, volatile memory 604 included in the electronic device 600 may store computer-readable and computer-executable instructions or software (e.g., applications) for implementing exemplary operations of the electronic device 600. The electronic device 600 also includes configurable and/or programmable processor 602 for executing computer-readable and computer-executable instructions or software stored in the volatile memory 604 and other programs for implementing exemplary embodiments of the present disclosure. Processor 602 may be a single core processor or multiple core processor. Processor 602 may be configured to execute one or more of the instructions described in connection with electronic device 600.

Volatile memory 604 may include a computer system memory or random access memory, such as DRAM, SRAM, EDO RAM, and the like. Volatile memory 604 may include other types of memory as well, or combinations thereof.

A user may interact with the electronic device 600 through a display device, such as a computer monitor, which may display one or more graphical user interfaces supplemented by I/O devices 608, which may include a projector 614, and scales 616.

The electronic device 600 may also include storage 606, such as a hard-drive, CD-ROM, or other computer readable media, for storing data and computer-readable instructions and/or software that implement exemplary embodiments of the present disclosure (e.g., applications). For example, storage 606 may include one or more databases for storing information associated with item packaging information and may be indexed accordingly. The database may be updated manually or automatically at any suitable time to add, delete, and/or update one or more data items in the databases.

The electronic device 600 can include a network interface 612 configured to interface via one or more network devices with one or more networks, for example, Local Area Network (LAN), Wide Area Network (WAN) or the Internet through a variety of connections including, but not limited to, standard telephone lines, LAN or WAN links (for example, 802.11, T1, T3, 56 kb, X.25), broadband connections (for example, ISDN, Frame Relay, ATM), wireless connections, controller area network (CAN), or some combination of any or all of the above. In exemplary embodiments, the network interface 612 may include one or more antennas to facilitate wireless communication between the electronic device 600 and a network and/or between the electronic device 600 and other electronic devices. The network interface 612 may include a built-in network adapter, network interface card, PCMCIA network card, card bus network adapter, wireless network adapter, USB network adapter, modem or any other device suitable for interfacing the electronic device 600 to any type of network capable of communication and performing the operations described herein.

In another embodiment, the concepts described herein with respect to pallet building systems may be applied to applications designed for larger loads that do not utilize pallets. For example, a loading dock in which a trailer container is loaded, such as a multi-modal container, may be able to utilize the pallet building system concepts previously described. For example, in an embodiment, a floor of the multi-modal container may be loaded instead of a pallet being built. A projector may be mounted on the dock ceiling instead of being located on a mast of a forklift. A 3D model may be built by a computing device or other electronic device equipped with a processor based on item information and pre-defined constraints as described above for the loading of pallets that virtually arranges the items into cross sections (layers) of items to load into the container. The projector may project a keystone-corrected image of the next item in a cross section of the model onto the floor of the container (or onto an already loaded item) so that an individual tasked with loading the container knows where to place the next item. Optionally, weight sensors may be utilized to confirm correct placement of the item on the floor of the container by sending weight measurements after the placement of each item to the computing device to confirm the accuracy of the placement of the item.

In describing exemplary embodiments, specific terminology is used for the sake of clarity. For purposes of description, each specific term is intended to at least include all technical and functional equivalents that operate in a similar manner to accomplish a similar purpose. Additionally, in some instances where a particular exemplary embodiment includes a multiple system elements, device components or method steps, those elements, components or steps may be replaced with a single element, component or step. Likewise, a single element, component or step may be replaced with multiple elements, components or steps that serve the same purpose. Moreover, while exemplary embodiments have been shown and described with references to particular embodiments thereof, those of ordinary skill in the art will understand that various substitutions and alterations in form and detail may be made therein without departing from the scope of the present disclosure. Further still, other aspects, functions and advantages are also within the scope of the present disclosure.

Exemplary flowcharts are provided herein for illustrative purposes and are non-limiting examples of methods. One of ordinary skill in the art will recognize that exemplary methods may include more or fewer steps than those illustrated in the exemplary flowcharts, and that the steps in the exemplary flowcharts may be performed in a different order than the order shown in the illustrative flowcharts.

We claim:

1. A pallet optimization system, comprising:
a pallet;
a computing device equipped with a processor and configured to execute an optimization module;
a projector communicatively coupled to the computing device, wherein the projector is configured to project an image onto a surface of the pallet and onto a surface of items disposed on the pallet;
a plurality of weight sensors disposed on the pallet and communicatively coupled to the computing device,
wherein the optimization module when executed on the computing device:
receives a plurality of item information corresponding to a plurality of items to be stored on the pallet, the item information including a size, a weight and a type of item;
arranges virtually the items on the pallet based on the item information and pre-defined constraints associated with the pallet;
generates a three dimensional (3D) model based on the virtual arranging;
identifies a plurality of cross sections of items in the 3D model;
transmits a command to the projector to project a first image of a item included in one of the plurality of cross sections onto at least one of the surface of the pallet and the surface of a item disposed on the pallet,
receives a measurement from the plurality of weight sensors following a placement of a physical item corresponding to the first image on the pallet, and
determines, based on the measurement, an accuracy of a placement of the item at a location indicated by the first image.

2. The system of claim 1 wherein the optimization module when executed further:
transmits a command to the projector to project a second image included in one of the plurality of cross sections onto at least one of the surface of the pallet and the surface of a item disposed on the pallet following a determination that the accuracy of the placement of the item meets a pre-defined threshold, the second image different than the first.

3. The system of claim 1 wherein the optimization module when executed further:
alerts a user that misplacement of the item against the projection has occurred following a determination that the accuracy of the placement of the item fails to meets a pre-defined threshold, the alert transmitting a command to the projector to project a third image indicating steps for correction of the misplacement.

4. The system of claim 3 wherein the third image includes textual information indicating an issue with the placement.

5. The system of claim 3 wherein the alerting includes an auditory alert indicating misplacement and steps for correction.

6. The system of claim 1 wherein the computing device, projector and plurality of weight sensors are coupled to a pallet jack.

7. The system of claim 1 wherein the computing device, projector and plurality of weight sensors are coupled to a trailer.

8. A method for optimized placement of items on a pallet comprising:
receiving a plurality of item information corresponding to a plurality of items to be stored on the pallet, the item information including a size, a weight and a type of item;
arranging virtually the items on the pallet based on the item information, and pre-defined constraints associated with the pallet;
generating a three dimensional (3D) model based on the virtual arranging;
identifying a plurality of cross sections of items in the 3D model;
transmitting a command to a projector to project a first image of a item included in one of the plurality of cross sections on to at least one of the surface of the pallet and the surface of a item disposed on the pallet,
receiving a measurement from a plurality of weight sensors following a placement of a physical item corresponding to the first image on the pallet, and
determining, based on the measurement, an accuracy of a placement of the item at a location indicated by the first image.

9. The method of claim 8, further comprising, transmitting a command to the projector to project a second image included in one of the plurality of cross sections onto at least one of the surface of the pallet and the surface of a item disposed on the pallet following a determination that the accuracy of the placement of the item meets a pre-defined threshold

10. The method of claim 8, further comprising alerting a user that misplacement of the item against the projection has occurred following a determination that the accuracy of the placement of the item fails to meets a pre-defined threshold, the alert transmitting a command to the projector to project a third image indicating steps for correction of the misplacement.

11. The method of claim 10, wherein the third image includes textual information indicating an issue with the placement.

12. The method of claim 10, wherein the alerting includes an auditory alert indicating misplacement and steps for correction.

13. The method of claim 8, wherein a computing device, the projector and the plurality of weight sensors are coupled to a pallet jack.

14. The method of claim 8, wherein a computing device, the projector and the plurality of weight sensors are coupled to a trailer.

15. A pallet optimization forklift, comprising:
a computing device equipped with a processor and configured to execute an optimization module;
a projector communicatively coupled to the computing device, wherein the projector is configured to project an image onto a surface of a pallet and onto a surface of items disposed on the pallet;
wherein the optimization module when executed on the computing device:
receives a plurality of item information corresponding to a plurality of items to be stored on the pallet, the item information including a size, a weight and a type of item;
arranges virtually the items on the pallet based on the item information and pre-defined constraints associated with the pallet;
generates a three dimensional (3D) model based on the virtual arranging;
identifies a plurality of cross sections of items in the 3D model;
transmits a command to the projector to project a first image of a item included in one of the plurality of cross sections onto at least one of the surface of the pallet and the surface of a item disposed on the pallet,
receives a measurement from a plurality of weight sensors on the pallet following a placement of a physical item corresponding to the first image on the pallet, and
determines, based on the measurement, an accuracy of a placement of the item at a location indicated by the first image.

16. The pallet optimization forklift of claim 15 wherein the optimization module when executed further:
transmits a command to the projector to project a second image included in one of the plurality of cross sections onto at least one of the surface of the pallet and the surface of a item disposed on the pallet following a determination that the accuracy of the placement of the item meets a pre-defined threshold, the second image different than the first.

17. The pallet optimization forklift of claim 15 wherein the optimization module when executed further:
alerts a user that misplacement of the item against the projection has occurred following a determination that the accuracy of the placement of the item fails to meets a pre-defined threshold, the alert transmitting a command to the projector to project a third image indicating steps for correction of the misplacement.

18. The pallet optimization forklift of claim 17, wherein the third image includes textual information indicating an issue with the placement.

19. The pallet optimization forklift of claim 17, wherein the alerting includes an auditory alert indicating misplacement and steps for correction.
